(19) United States
(12) Patent Application Publication
(10) Pub. No.: US 2021/0162537 A1
(43) Pub. Date: Jun. 3, 2021

(54) LASER CLEANING SYSTEM

(71) Applicant: Automation Innovation Pty Ltd, Keysborough (AU)

(72) Inventors: Walter MEYLER, Lysterfield (AU); Marcus CLARKE, Mount Martha (AU)

(21) Appl. No.: 17/052,298

(22) PCT Filed: May 7, 2019
(86) PCT No.: PCT/AU2019/050416

§ 371 Date: Nov. 2, 2020

(30) Foreign Application Priority Data
May 8, 2018 (AU) 2018203176

(51) Int. Cl. B23K 26/08; B08B 7/00; B23K 26/36; B23K 26/03; B29C 33/72

(52) U.S. Cl. CPC B23K 26/0884; B08B 7/0042; B29C 33/72; B23K 26/032; B23K 26/36

(57) ABSTRACT

The invention relates to an automated cleaning system for cleaning an object, comprising a laser configured to be directed at the object, to remove contaminants from the object, detection apparatus to identify a position of the object, movement apparatus to move the object into and/or out of a cleaning position, and control apparatus to direct the laser at the object in the cleaning position, and operate the laser to clean the object.

### FIELD

The invention relates to cleaning apparatus. For convenience, the invention will be described with reference to the cleaning of moulds used in the manufacture of glass bottles. However, the invention has broader application.

### BACKGROUND

One common process to manufacture of glass containers or bottles is a two-stage moulding process. In the first stage, molten glass is poured into a first mould to form a parison of a certain shape and dimensions. In the second stage, the parison is moved to a second mould, where it is blown into the mould to take the final shape of the glass bottle or container.

Typically, a graphite based lubricant solution is applied to the moulds between each manufacturing cycle, to facilitate removal of the glass item from the mould. Over time, residual lubricant (and/or other contaminants) builds up as a scale on the moulds. Therefore, the moulds need to be periodically removed for cleaning.

Cleaning usually takes place at a cleaning site that is remote from the manufacturing facility. The prevailing cleaning system takes about 4 hours for a set of moulds, and involves shot blasting the moulds with ceramic, metal or sand beads.

Under this system, the blasting erodes the parent material of the mould. The means that, over time, the mould tolerance deteriorates, and this deterioration must be compensated for during the manufacturing process (for example by adding extra glass to the shot to maintain the volume of the container—which can be very expensive), or alternatively the mould must be replaced (i.e. the cleaning process can decrease the lifespan of the mould).

The gradual erosion of the mould material also means that its square edges become dulled, and the dulled edges need to be dressed by a qualified tradesperson. This is labour-and time-intensive, and also expensive.

Furthermore, the erosion of the mould can cause fine glass features (such as a logo, branding or other indicia) to become dulled and unclear.

Another problem with the current system is that ceramic can beads get stuck in the air ports of a mould. This causes issues in the main manufacturing line—in particular, it can cause contamination and defects in containers.

Finally, the blasting process is a completely manual process, and inconsistencies can arise between different operators.

It is an object of the invention to substantially overcome or at least ameliorate one or more of the disadvantages of the prior art, or at least provide a useful alternative to conventional cleaning apparatus.

### SUMMARY

In an aspect of the present invention, there is provided an automated cleaning system comprising:
a laser configured to be directed at the object, to remove contaminants from the object;
detection apparatus to identify a position of the object;
movement apparatus to move the object into and/or out of a cleaning position; and
control apparatus to direct the laser at the object in the cleaning position, and operate the laser to clean the object.

The movement apparatus may comprise a handling robot having a holding arm to hold the object, move the object to or from the cleaning position, and then release the object.

The control apparatus may comprise a cleaning robot configured to move the laser and selectively turn the laser on and off. The cleaning robot may comprise a processor in communication with the detection apparatus, the processor being configured to move the laser in a cleaning pattern over the object, in response to observations made by the detection apparatus.

The detection apparatus may comprise one or more cameras.

The automated cleaning system may further comprise a housing to provide an isolated space for cleaning of the object. The housing may include labyrinth gates into and out of the isolated space.

The automated cleaning system may further comprise carriage apparatus to carry the object into and out of the isolated space. The carriage apparatus may be a trolley for carrying a set of objects, and the movement apparatus may sequentially move each object into the cleaning position for cleaning, and return the object to the trolley after cleaning. Alternatively, the carriage apparatus may include conveyor belt(s) or other mechanisms for carrying object(s) into and/or out of the isolated space.

In another aspect of the invention, there is provided a method for automated cleaning of an object, the method comprising:
carrying the object into an isolated space;
moving the object to a cleaning position, using a handling robot;
cleaning the object using a laser mounted on a cleaning robot; and
carrying the object out of the isolated space.

Through the use of the invention, objects can be cleaned in a precise and repeatable fashion. The use of a laser has advantages over conventional shot blasting methods used for cleaning glass manufacturing moulds, in that there is little if any erosion of the moulds.

In addition, the use of robots within an isolated space means that operators and other workers at the cleaning facility are not exposed to noxious fumes generated during the laser cleaning process.

In a further aspect of the invention, the system may further include an inspection device to checking the cleanliness of the object after cleaning.

In a further aspect of the invention, the system may further include a user interface, including a monitor, input device(s) and associated software. The user interface may allow the operator to program the profile of the object in an intuitive manner without the need to program the robots directly. The procedure for programming the profile of the object may include providing a predetermined profile shape type; and prompting a user to specify one or more parameters of the predetermined profile shape type.

A detailed description of one or more embodiments of the invention is provided below, along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents.

For the purpose of example, numerous specific details are set forth in the following description in order to provide a thorough understanding of the present invention. The present invention may be practiced according to the claims without some or all of these specific details. For the purposes of clarity, technical material that is known in the technical fields related to the invention has not been described in detail so that the present invention is not unnecessarily obscured.

### BRIEF DESCRIPTION OF THE DRAWINGS

Preferred embodiments of the invention will now be described with reference to the accompanying drawings wherein:

FIGS. 1 to 7 sequentially depict the operation of a cleaning system according to an embodiment of the present invention, to clean a glass mould. Note that various components have been removed or cut away in different figures, to best show the relevant features.

FIG. 8 is a top view of a laser cleaning system according to an embodiment of the invention, with the housing partially cut away.

FIG. 9 is a perspective view of a mould cleaning table for use in accordance with an embodiment of the invention.

FIG. 10 depicts in greater detail the laser cleaning operation of the system of FIG. 1.

FIG. 11 is a perspective view of the laser cleaning system of FIG. 1, with parts of the housing cut away.

FIG. 12 depicts a shape for a bottle formed by a mould to be cleaned in accordance with embodiments of the invention.

FIG. 13 depicts cross-section A-A from FIG. 12.

### DETAILED DESCRIPTION

In accordance with an embodiment of the invention, there is provided a laser cleaning system 100 including a housing 200 which provides an isolated space for cleaning of glass manufacturing moulds 700. Entry into and out of the isolated space is provided through a pair of labyrinth gates 210.

Within the isolated space, there are a provided a pair of robots—a handling robot 300, and a cleaning robot 400. A trolley 500 is provided to carry moulds 700 into and out of the housing 200. In addition, cameras 600 are also provided to observe the position of items within the isolated space.

The handling robot 300 includes a handling arm 310 with a claw 320 at its end, which is sized appropriately to grasp the moulds 700. The handling robot 300 includes a processor, which receives image data from the cameras 600, showing the position of mould(s) 700 within the isolated space. The image data from the cameras 600 may be received in raw form by the handling robot 300, and analysed to determine the position of the moulds 700. Alternatively, the image data may be externally processed (e.g. by a separate processor associated with the cameras 600) to identify the position of relevant features within the housing 200, and this position data can then be transmitted to the robots 300, 400. Once the position of the moulds 700 is determined, the processor of the handling robot 300 can then control the operation of the handling harm 310 and claw 320, to move the moulds 700 for cleaning, as explained below.

The cleaning robot 400 includes a control arm 410, which has a laser 420 mounted on it. Different types of laser may be used depending on the particular application, but in this embodiment, the laser is preferably a relatively high powered industrial laser in the range of 200 W to 1000 W. In one (non-limiting) embodiment, the laser may be a 1000 W laser operating at approximately 1064 nm wavelength. The cleaning robot 400 also includes a processor in communication with the cameras 600. Image data from the cameras 600 can be used to precisely operate the laser 420 to clean the moulds 700, as explained in more detail below.

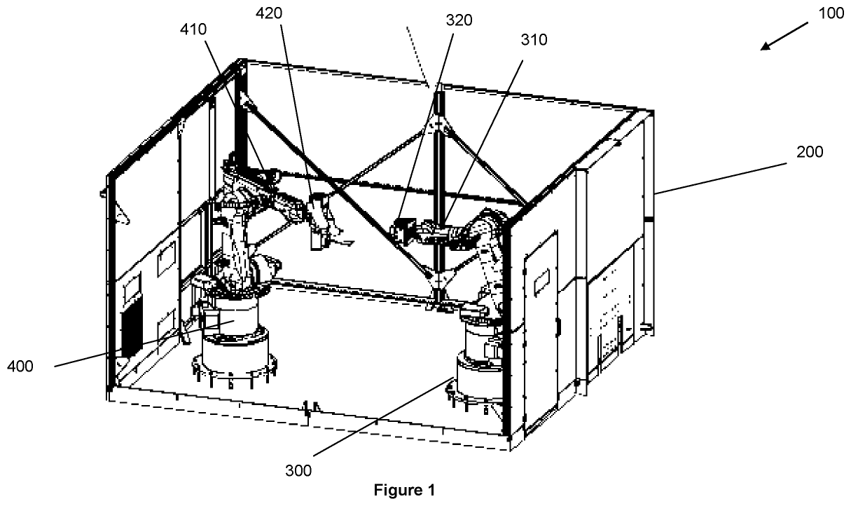

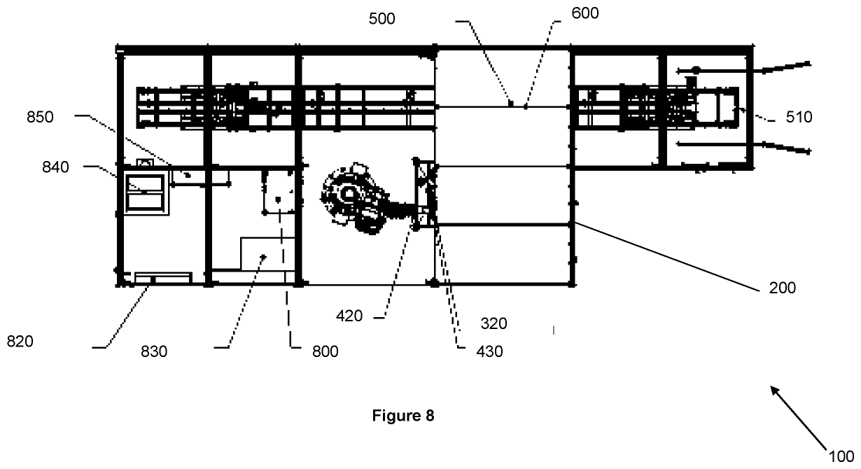

FIGS. 1 to 7 show the operation of the cleaning system of this embodiment of the invention. For convenience, to show the system components in operation, various features have been removed or cut away from these Figures. However, FIGS. 8 (top view) and 11 (cut-away perspective view) provide a more complete overview of the entire system 100.

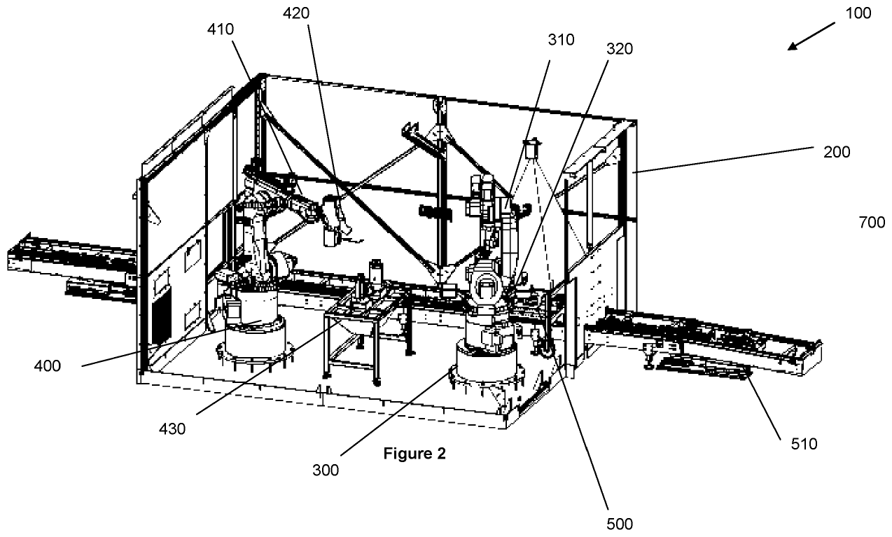

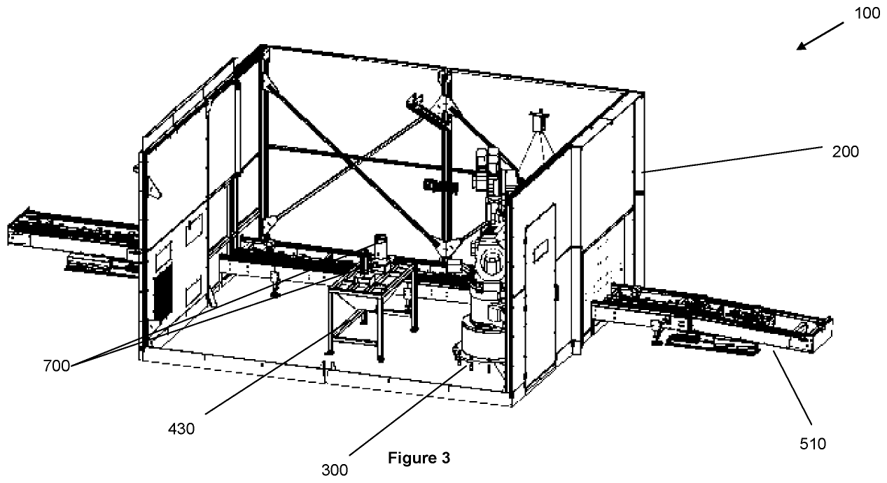

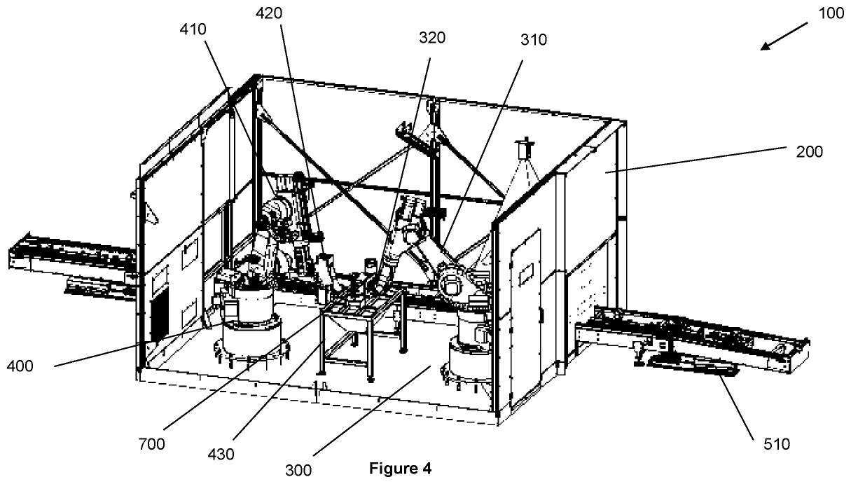

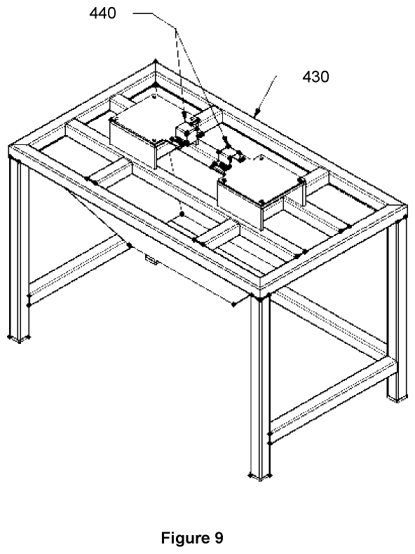

In FIG. 1, the housing 200 is empty apart from the robots 300, 400. FIG. 2 shows the entry of trolley 500, past labyrinth gates 210. Within the trolley 500 are a set of moulds 700 for cleaning. In this embodiment, a single mould 700 is picked up by the claw 320 of the handling robot 300, and transferred into a cleaning position within a cleaning station 430 of the cleaning robot 400, as shown in FIGS. 3 and 4. The use of a specific cleaning station 430 ensures that the mould 700 is precisely positioned for cleaning, and ensures that the cleaning robot 400 can clearly identify features of the mould 700 that require cleaning. As shown in FIG. 9, the cleaning station includes mould detection sensors 440, which detect when a mould is in place and ready for cleaning.

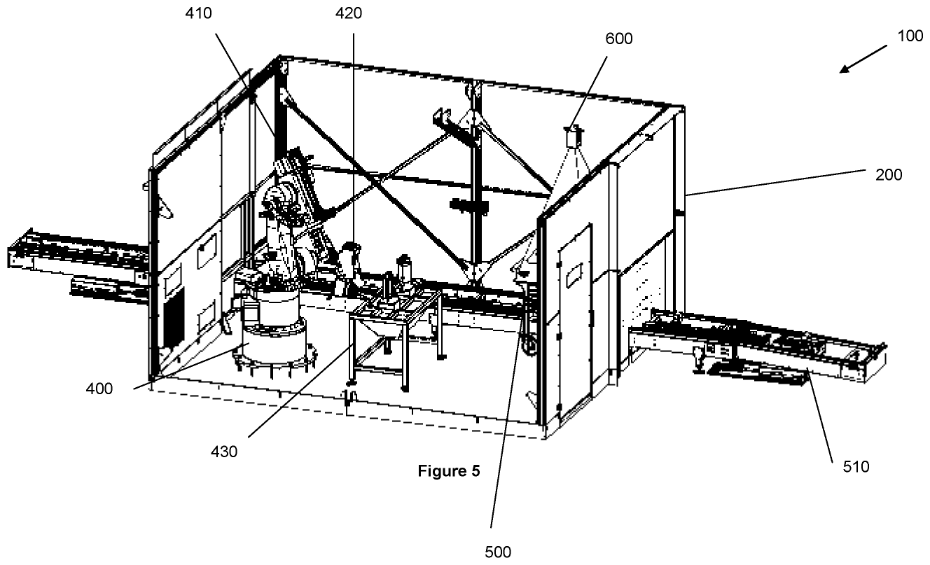

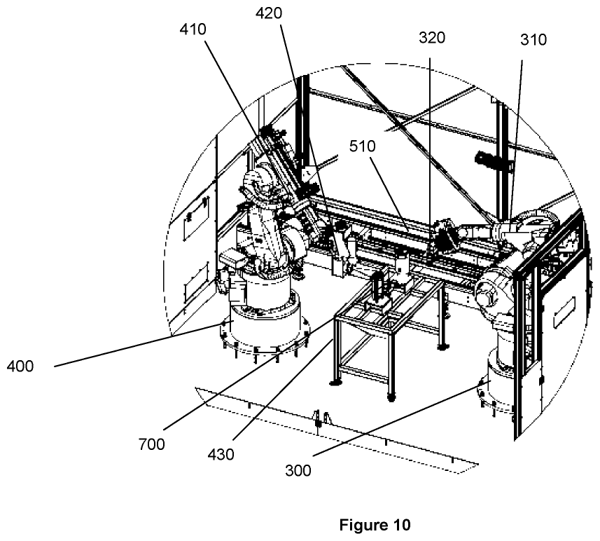

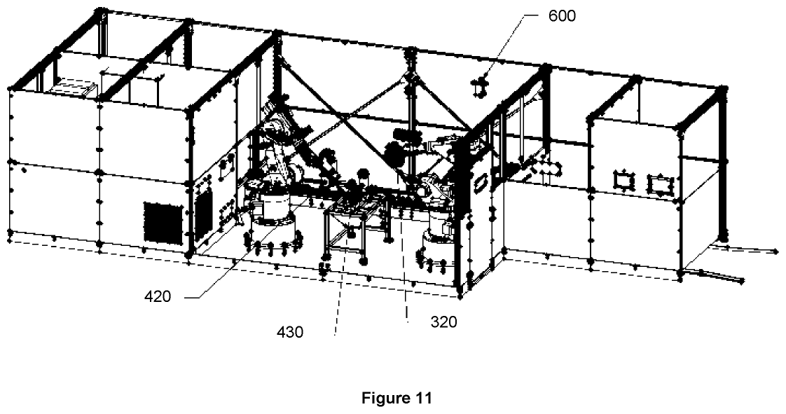

FIG. 5 depicts the cleaning robot 400 in operation, cleaning a mould 700 using the laser. The cleaning operation, at this stage, may follow a variety of cleaning algorithms depending on the particular object to be cleaned, and the nature of any scale or other contaminants. FIG. 10 depicts this cleaning operation in more detail.

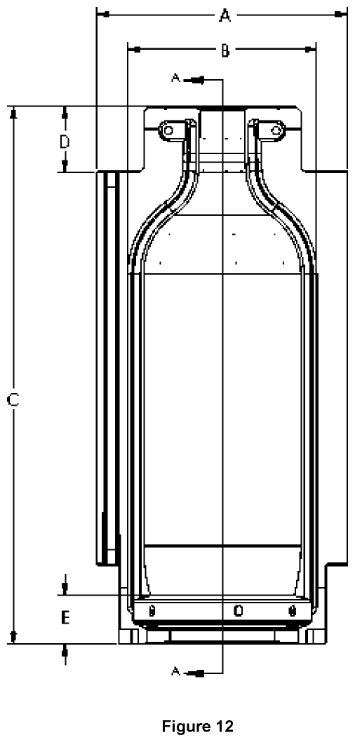

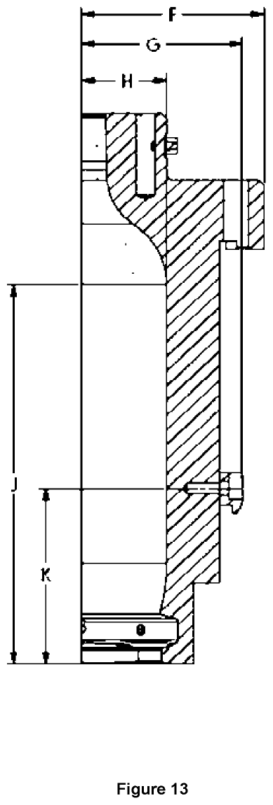

One option is be for the cleaning robot to simply follow a predetermined pattern to ensure the laser is applied to all areas of the mould 700. However, this will usually be inefficient. Accordingly, data from the cameras 600 is preferably used to precisely identify the mould features and the areas of contamination. For example, contaminated areas are frequently of a different colour to the rest of the mould 700. Contamination of moulds 700 also typically occurs more frequently in some areas than in others—for example, around the edges of the mould. The image data from cameras 600 may be analysed to look for colours associated with contamination, and or shapes within the mould 700 (based on the mould design) that are susceptible to scale build up. This allows contaminated areas to be identified more precisely, for cleaning by the cleaning robot 400. The identification of contaminated areas may be assisted if mould profile data (for the mould 700 to be cleaned) is loaded into the control software for the cleaning robot 400 (and/or handling robot 300), via a user interface. This provides a simpler way to program mould profile data into the control system. More detail of this step is described below with reference to FIGS. 12 and 13.

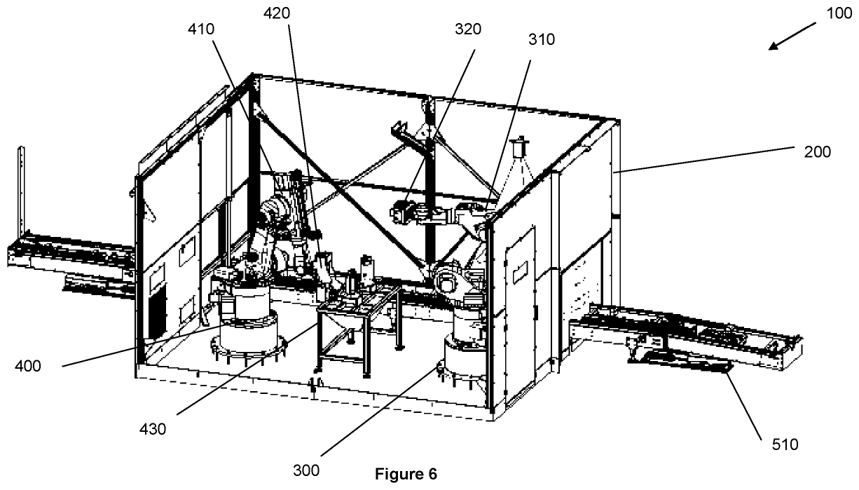

Once the mould 700 has been cleaned, it is returned to the trolley 500 by the handling robot 300, as shown in FIG. 6. The next mould 700 can then be picked up, moved to the cleaning position, cleaned and returned to the trolley 500 as described above.

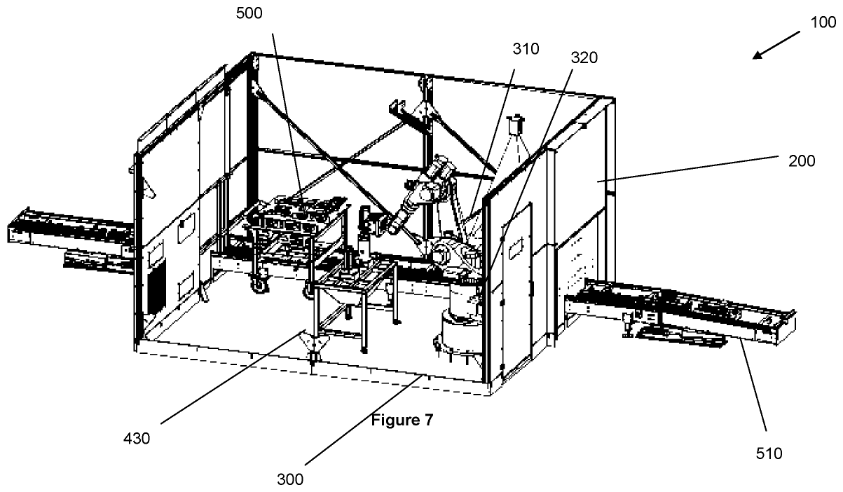

Once an entire set of moulds 700 have been cleaned, the trolley can exit the housing 200 through labyrinth gate 210, as shown in FIG. 7.

Initial trials indicate that the cleaning system 100 according to this embodiment of the present invention can clean a set of moulds in far less time than conventional manual cleaning methods. In addition, cleaning using the present invention appears to result in significantly less erosion of the parent mould material.

One risk to the smooth operation of the cleaning system 100 is the state of the lens on the laser. In particular, the lens should be maintained as clean as possible, because contamination can cause cracking of the lens. To help avoid this, an exhaust system may be used to pull contamination and fumes out of the isolated space. However, preferably, a lens monitor is also included in the system 100. In particular, an infrared sensor may be used to monitor the temperature of the lens, because the temperature of the lens has a direct relationship to the level of contamination on the lens. In this embodiment, the temperature of the lens is checked at substantially regular intervals, and if the temperature rises above a certain threshold, this mean the lens may heading for failure. The cleaning process should therefore be temporarily stopped to allow the lens to be cleaned. The particular temperature will depend on the type and quality of the lens itself.

In relation to programming the mould profile, the system preferably provides an intuitive way for an operator to specify the object profile. Because information is known about the object in advance (for example, that it is a glass mould for a glass bottle), a generalised object profile may be used, with parameters allowing an operator to specify the shape of this particular object type. In this case, glass bottles have a known generalised shape, but a particular bottle may be taller, shorter, or have different contours to other glass bottles. Accordingly, a mould shape may be specified using the parameters of the glass bottle it is used to form. FIG. 12 depicts, for example, a generalised bottle shape, with parameters A, B, C, D, E, F, G, H, I, J and K defining the dimensions of the bottle.

To specify a mould shape, an operator may first select a ‘new product’ option, and elect to teach the system a new mould shape. The operator is then prompted, by the system, to specify the parameters of the predetermined profile shape type (e.g. options A to K shown in FIGS. 12 and 13, although different numbers of parameters may be specified for different object types). These dimensional parameters may be entered in mm or any other desired measure of distance.

Once all the data values have been entered, the operator can save the product as a new or existing product. These steps are preferably performed on a separate user interface machine. When this product is selected to run, to be cleaned by the present invention, the cleaning robot will be passed this data and will change the program automatically according to the object profile created—i.e. it will be informed how and where the object will most need to be cleaned.

Throughout this specification and the claims which follow, unless the context requires otherwise, the word “comprise”, and variations such as “comprises” and “comprising”, will be understood to imply the inclusion of a stated integer or step or group of integers or steps, but not the exclusion of any other integer or step or group of integers or steps.

The reference in this specification to any prior publication (or information derived from it), or to any matter which is known is not, and should not be taken as an acknowledgment or admission or any form of suggestion that that prior publication (or information derived from it) or known matter forms part of the common general knowledge in the field of endeavour to which this specification relates.

1. An automated cleaning system for cleaning an object, comprising:
a laser configured to be directed at the object, to remove contaminants from the object;
detection apparatus to identify a position of the object;
movement apparatus to move the object into and/or out of a cleaning position; and
control apparatus to direct the laser at the object in the cleaning position, and operate the laser to clean the object.

2. The automated cleaning system of claim 1, wherein the movement apparatus comprises a handling robot having a holding arm to hold the object, move the object to or from the cleaning position, and then release the object.

3. The automated cleaning system of claim 1, wherein the control apparatus comprises a cleaning robot configured to move the laser and selectively turn the laser on and off.

4. The automated cleaning system of claim 3, wherein the cleaning robot comprises a processor in communication with the detection apparatus, the processor being configured to move the laser in a cleaning pattern over the object, in response to observations made by the detection apparatus.

5. The automated cleaning system of claim 1, wherein the detection apparatus comprises one or more cameras.

6. The automated cleaning system of claim 1, further comprising a housing to provide an isolated space for cleaning of the object.

7. The automated cleaning system of claim 6, wherein the housing comprises labyrinth gates into and out of the isolated space.

8. The automated cleaning system of claim 6, further comprising carriage apparatus to carry the object into and out of the isolated space.

9. The automated cleaning system of claim 8, wherein the carriage apparatus comprises an automated trolley for carrying a set of objects, and wherein the movement apparatus sequentially moves each object into the cleaning position for cleaning, and returns the object to the trolley after cleaning.

10. The automated cleaning system of claim 1, further comprising an exhaust system to draw away fumes from the laser cleaning operation.

11. The automated cleaning system of claim 1, wherein the laser comprises a lens, and further comprising a lens monitor to detect potential failure of the lens.

12. The automated cleaning system of claim 11, wherein the lens monitor comprises an infrared sensor, to monitor the temperature of the lens.

13. The automated cleaning system of preceding claim 1, wherein the object is a mould for use in manufacturing glass containers.

14. The automated cleaning system of claim 1, wherein the laser has a power output of 200 to 1,000 Watts.

15. A method for automated cleaning of an object, the method comprising:
carrying the object into an isolated space;
moving the object to a cleaning position, using a handling robot;
cleaning the object using a laser mounted on a cleaning robot; and
carrying the object out of the isolated space.

16. The method of claim 15, wherein the object is carried into and out of the isolated space using a trolley.

17. The method of claim 16, wherein the trolley carries a set of objects into and out of the isolated space, and the method comprises sequentially moving each object from the trolley to the cleaning position, cleaning each object, and returning each object to the trolley.

18. The method of any one of claim 15, wherein the object is a mould for use in manufacturing glass containers.
